(19) United States
(12) Patent Application Publication
(10) Pub. No.: US 2003/0209518 A1
(43) Pub. Date: Nov. 13, 2003

(54) Method of detecting abnormal chamber conditions in etcher

(75) Inventors: Lu-Fu Liao, Changhua City (TW); Tsai-Yi Chen, Jubei City (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/141,373

(22) Filed: May 8, 2002

(51) Int. Cl. C03C 25/68

(52) U.S. Cl. 216/59

(57) ABSTRACT

A method for detecting abnormal conditions in an etching chamber for semiconductors. A plasma intensity control standard or calibration curve is first obtained for the optimal etching of semiconductors in a particular application, in which the plasma intensity profile for optimal etching characteristics is plotted against elapsed etching time in seconds. Subsequent semiconductors are etched according to the optimum plasma intensity generated from the control or calibration curve to facilitate optimum integrated circuit quality, wafer throughput and processing efficiency.

### FIELD OF THE INVENTION

The present invention relates to dry etching processes for etching insulative and conductive layers on a semiconductor wafer. More particularly, the invention relates to a method of detecting abnormal etch chamber conditions based on plasma intensity to prevent wafer overetching or underetching during an etching process.

### BACKGROUND OF THE INVENTION

Integrated circuits are formed on a semiconductor substrate, which is typically composed of silicon. Such formation of integrated circuits involves sequentially forming or depositing multiple electrically conductive and insulative layers in or on the substrate. Etching processes may then be used to form geometric patterns in the layers or vias for electrical contact between the layers. Etching processes include “wet” etching, in which one or more chemical reagents are brought into direct contact with the substrate, and “dry” etching, such as plasma etching.

Various types of plasma etching processes are known in the art, including plasma etching, reactive ion (RI) etching and reactive ion beam etching. In each of these plasma processes, a gas is first introducted into a reaction chamber and then plasma is generated from the gas. This is accomplished by dissociation of the gas into ions, free radicals and electrons by using an RF (radio frequency) generator, which includes one or more electrodes. The electrodes are accelerated in an electric field generated by the electrodes, and the energized electrons strike gas molecules to form additional ions, free radicals and electrons, which strike additional gas molecules, and the plasma eventually becomes self-sustaining. The ions, free radicals and electrons in the plasma react chemically with the layer material on the semiconductor wafer to form residual products which leave the wafer surface and thus, etch the material from the wafer.

Referring to the schematic of FIG. 1, a conventional plasma etching system, such as a Lam 9100 TCP (transferred coupled plasma) etcher, manufactured by Lam Research, Inc., is generally indicated by reference numeral 10. The etching system 10 includes a reaction chamber 12 having a typically grounded chamber wall 14. An electrode, such as a planar coil electrode 16, is positioned adjacent to a dielectric plate 18 which separates the electrode 16 from the interior of the reaction chamber 12. Plasma-generating source gases are provided by a gas supply 20. The gas supply 20 is coupled with the reaction chamber 12 through a gas control panel 22, which selects and controls the flow of the source gases into the chamber 12. Volatile reaction products and unreacted plasma species are removed from the reaction chamber 12 by a gas removal mechanism, such as a vacuum pump 24 through a throttle valve 26.

The dielectric plate 18 illustrated in FIG. 1 may serve multiple purposes and have multiple structural features, as is well known in the art. For example, the dielectric plate 18 may include features for introducing the source gases into the reaction chamber 12, as well as those structures associated with physically separating the electrode 16 from the interior of the chamber 12.

Electrode power such as a high voltage signal, provided by a power generator such as an RF (radio frequency) generator 28, is applied to the electrode 16 to ignite and sustain a plasma in the reaction chamber 12. The RF generator 28 is coupled to one end of the planar coil electrode 16 through a matching network 30, which functions to primarily match impedances, as is well known in the art. The other end of the planar coil electrode 16 is coupled to ground potential by a terminal capacitor 32 or C.sub.T. While frequently included in the matching network 30, the terminal capacitor or C.sub.T 32 is illustrated separately in FIG. 1.

Ignition of a plasma in the reaction chamber 12 is accomplished primarily by electrostatic coupling of the electrode 16 with the source gases, due to the large-magnitude voltage applied to the electrode 16 and the resulting electric fields produced in the reaction chamber 12. Once ignited, the plasma is sustained by electromagnetic induction effects associated with time-varying magnetic fields produced by the alternating currents applied to the electrode 16. The plasma may become self-sustaining in the reaction chamber 12 due to the generation of energized electrons from the source gases and striking of the electrons with gas molecules to generate additional ions, free radicals and electrons. A semiconductor wafer 34 is positioned in the reaction chamber 12 and is supported by a wafer platform or chuck 36. The chuck 36 is typically electrically-biased to provide ion energies that are independent of the RF voltage applied to the electrode 16 and that impact the wafer 34.

Typically, the voltage varies as a function of position along the coil electrode 16, with relatively higher-amplitude voltages occurring at certain positions along the electrode 16 and relatively lower-amplitude voltages occurring at other positions along the electrode 16. A relatively large electric field strength is required to ignite plasmas in the reaction chamber 12. Accordingly, to create such an electric field it is desirable to provide the relatively higher-amplitude voltages at locations along the electrode 16 which are close to the grounded chamber wall 14.

As discussed above, plasma includes high-energy ions, free radicals and electrons which react chemically with the surface material of the semiconductor wafer to form reaction produces that leave the wafer surface, thereby etching a geometrical pattern or a via in a wafer layer. Plasma intensity depends on the type of etchant gas or gases used, as well as the etchant gas pressure and temperature and the radio frequency generated at the electrode 16 by the RF generator 28. If any of these factors changes during the process, the plasma intensity may increase or decrease with respect to the plasma intensity level required for optimum etching in a particular application. Decreased plasma intensity results in decreased, and thus incomplete, etching. Increased plasma intensity, on the other hand, can cause overetching and plasma-induced damage of the wafers. Plasma-induced damage includes trapped interface charges, material defects migration into bulk materials, and contamination caused by the deposition of etch products on material surfaces. Etch damage induced by reactive plasma can alter the qualities of sensitive IC components such as Schottky diodes, the rectifying capability of which can be reduced considerably. Heavy-polymer deposition during oxide contact hole etching may cause high-contact resistance.

Furthermore, plasma-etching techniques are incapable of discriminating between the layer or layers to be etched and the underlying layer or layers, which should remain unaffected by the etching process. For these reasons, the plasma reactor must be equipped with a monitor that indicates when the etching process is to be stopped. Such a monitor may utilize an end-point system or mode to terminate etching in order to prevent undesired etching of the underlying layer on the wafer.

One type of end point detection system commonly used in plasma etching processes is optical emission spectroscopy, which analyzes the light emitted by energized atoms and molecules in the gas discharge leading from the etching chamber. This is accomplished by using a detector equipped with a filter which lets light of a specific wavelength penetrate to the detector to analyze the concentration of excited products or reactants during the etching process. The emission signal generated by the gas discharge begins to rise or fall at the end of the etch cycle, thus indicating that material of a different chemical composition (that of the underlying layer) than that of the etched layer is being etched from the wafer surface.

Another end-point detection system includes laser inferometry, in which laser beams are directed toward the etched wafer surface. If the films on the wafer surface are transparent, then the laser beams reflected from the top and bottom of the etched layer interfere with each other. As the etching process reduces the thickness of the etched layer, the degree of interference between the laser beams changes. The elapsed time between the light maxima and light minima can be used to determine the etching rate. At the end of the etching process, the interference between the beams stops and the interference signal flattens out.

In contact etching processes, contact openings, or vias, are etched in an insulative layer to provide electrical contact between a conductive layer which underlies the insulative layer and a second conductive layer to subsequently be deposited on the insulative layer. In contact etching processes, the end point mode of determining the suitable end of an etching process cannot be used due to the relatively low exposure rate of the insulative layer to the plasma and because the plasma encounters no obvious stop layer to indicate when the etching process should be stopped. Therefore, a time mode is typically used to determine the end of contact etching processes.

According to the time mode, the time for plasma generation is programmed into the etcher. When the etch time has elapsed, plasma generation in the etcher may be manually or automatically terminated or attenuated at this point to prevent overetching of the semiconductor. However, the time mode fails to provide any indication of abnormal chamber conditions in the event that the plasma-forming source gas fails to initially ignite and generate the plasma in the chamber or the plasma intensity rises too high or falls too low for optimum etching. Consequently, batches of wafers may be under- or over-etched and require discarding.

It has been found that the intensity of the plasma in the etching chamber is a useful parameter for monitoring chamber conditions during etching. By initially obtaining a control standard or calibration curve to identify a plasma intensity threshold value for optimum etching results for a particular application, subsequent batches of wafers etched using the plasma intensity obtained from the control will facilitate optimum wafer etching characteristics and throughput.

### SUMMARY OF THE INVENTION

Accordingly, an object of the present invention is to provide a method for detecting abnormal or less-than-optimal conditions in an etching chamber for semiconductor processing.

Another object of the present invention is to provide a method for preventing over-etching and under-etching of material layers in the formation of integrated circuits on semiconductor wafers.

Still another object of the present invention is to provide a method for detecting abnormal conditions in various types of etchers.

Yet another object of the present invention is to provide a method which is applicable to detecting abnormal or less-than optimal etching conditions in a variety of dry etching processes.

A still further object of the present invention is to provide a method for detecting excessively high and excessively low plasma intensities during etching of material layers in the formation of integrated circuits on semiconductor wafers.

Yet another object of the present invention is to provide a method which utilizes plasma intensity to determine optimum chamber conditions for etching semiconductor wafers.

A still further object of the present invention is to provide a method which includes comparing plasma intensity profiles during individual or batch processing of semiconductor wafers to a previously-determined control profile for plasma intensity which represents the plasma intensity value for optimum etching of the wafer or wafers.

In accordance with these and other objects and advantages, the present invention comprises a method for detecting abnormal conditions in an etching chamber for semiconductors. A plasma intensity control standard or calibration curve is first obtained for the optimal etching of semiconductors in a particular application, in which the plasma intensity profile for optimal etching characteristics is plotted against elapsed etching time in seconds. Subsequent semiconductors are etched according to the optimum plasma intensity generated from the control or calibration curve to facilitate optimum integrated circuit quality, wafer throughput and processing efficiency.

### BRIEF DESCRIPTION OF THE DRAWINGS

The invention will now be described, by way of example, with reference to the accompanying drawings, in which:

FIG. 1 is a schematic view of a typical conventional plasma etching system such as a Lam 9100 TCP plasma etcher;

FIG. 2 is a graph illustrating an example of a spectroscopy control or calibration curve obtained for plasma intensity during a typical contact etching process, with plasma intensity plotted as a function of time;

FIG. 3 is a graph illustrating an example of a spectroscopy curve obtained for plasma intensity during individual or batch processing of semiconductor wafers in a contact etching process, with plasma intensity plotted as a function of time, wherein the plasma intensity curve falls below the calibration curve for plasma intensity; and

FIG. 4 is a graph illustrating an example of a spectroscopy curve obtained for plasma intensity during individual or batch processing of semiconductor wafers in a contact etching process, with plasma intensity plotted as a function of time, wherein the plasma intensity curve rises above the calibration curve for plasma intensity.

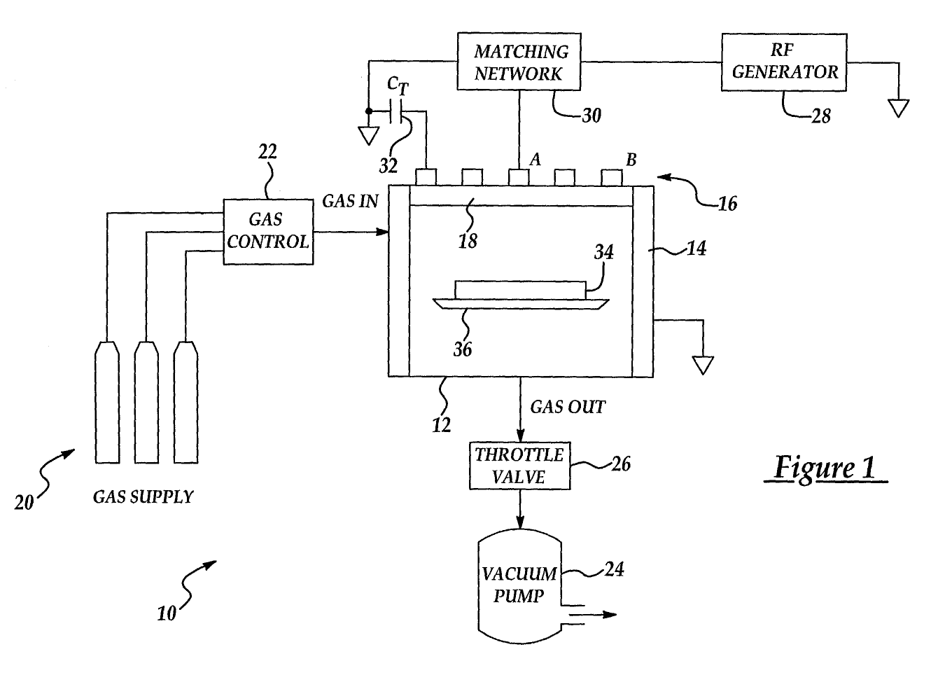

### DESCRIPTION OF THE PREFERRED EMBODIMENT

The present invention is particularly applicable to detecting abnormal or less-than-optimum chamber conditions in contact etching processes, in which conductive openings, or vias, are formed in an insulative layer on a semiconductor wafer to establish electrical contact between an electrically-conductive layer underlying the insulative layer and a second electrically-conductive layer to be subsequently deposited on the insulative layer. Such a process is not amenable to end-point determination of etching termination, since the etchant plasma does not reach a stop layer on the wafer to signal the end of the etching process. However, it will be appreciated by those skilled in the art that the method of the present invention is equally applicable to detecting abnormal or less-than-optimum chamber conditions in a variety of dry etching processes other than contact etching.

In a first step according to the method of the present invention, a control or calibration curve 40 is created through a trial-and-error process using conventional spectroscopy equipment (not illustrated) and techniques to determine the plasma intensity profile that will generate optimum results in etching a contact via through an insulative layer on a semiconductor wafer substrate 34 or for etching unmasked layer portions from the surface of the substrate 34, for example, as appropriate. This is accomplished by varying the radio frequency of the RF generator 28, as well as the type of gas, gas mixture and flow rates, gas pressure, and temperature in the reaction chamber 12, according to the knowledge of those skilled in the art. These parameters vary according to the particular type of dry etching process needed for a particular application, as is known by those skilled in the art.

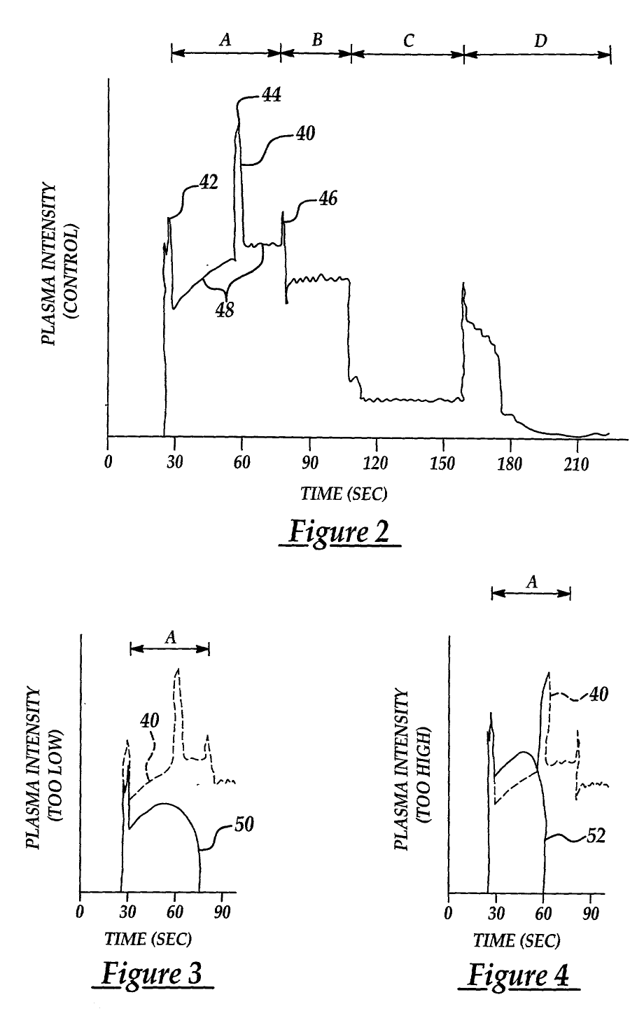

FIG. 2 illustrates an example of a plasma intensity spectroscopy calibration curve 40 obtained through trial-and-error to achieve optimal results in a contact dry etching process, with the elapsed process time in seconds progressing from the left to the right along the horizontal or “x” axis and the plasma intensity increasing upwardly along the vertical or “y” axis, away from the horizontal “x” axis. The time interval corresponding to the main etching step, in which a layer on the wafer 34 is etched to form a via or other geometric pattern (not illustrated) thereon, is designated by the letter “A” and begins as the plasma is generated from the source gas at about 25-30 seconds after onset of the process. Although the plasma intensity reaches relatively high levels with respect to a baseline level 48, as indicated by the spikes 42, 44 and 46, respectively, of the calibration curve 40, the plasma intensity stays within a particular range throughout the main etching step, typically until about 85-90 seconds after the onset of the process, at which time the main etching step is terminated either automatically or manually and the wafer 34 may be removed from the reaction chamber 12. The time interval represented by the letter “B” indicates overetching of the wafer 34 in the event that the wafer 34 remains exposed to the plasma in the reaction chamber 12 during the time indicated, typically during the time span of about 85-120 seconds after onset of the etching process. Plasma typically remains in the reaction chamber 12 throughout the subsequent chamber cleaning phase, the time interval of which is designated by the letter “C” and typically spans the period of about 120-160 seconds after the onset of the etching process. Finally, the RF generator 28, the gas supply 20 and other control components of the plasma etching system 10 are turned off, and any plasma remaining in the reaction chamber 12 is evacuated therefrom through the throttle valve 26 by operation of the vacuum pump 24. The various control components of the plasma etching system 10, such as gas flow rate, gas mixture and pressure, chamber temperature, and radio frequency are calibrated according to procedures which are well-known to those skilled in the art in order to reproduce the plasma intensity required for optimal etching in subsequent etching operations as indicated by the calibration curve 40.

FIG. 3 shows an illustrative partial plasma intensity curve 50 obtained during the progress of an etching process conducted after obtaining the calibration curve 40. During the etching process, the plasma intensity curve 50 is superimposed on a portion of the calibration curve 40 which corresponds to the main etching time segment “A”. This is accomplished using appropriate software in conjunction with the spectrometer (not illustrated) that is used to monitor the intensity of the plasma in the reaction chamber 12. As indicated by the plasma intensity curve 50, the plasma intensity of the etching process falls below the ideal or optimum plasma intensity which generated the calibration curve 40 of FIG. 2, obtained from the control. When it is apparent that the plasma intensity falls significantly (typically about 10% or more) below the plasma intensity of the calibration curve 40, the etching process is immediately terminated to prevent partial etching of the wafer or wafers 34 in the reaction chamber 12, since continued etching of the wafer or wafers 34 under those circumstances would result in incomplete etching thereof throughout the remaining duration of the etching process. It is understood that the plasma etching system 10 or spectrometer (not illustrated) may be equipped with the appropriate software for calculating the percentage difference between the plasma intensity curve 50 and the calibration curve 40, during progress of the etching process. The cause for the decreased plasma intensity, such as tool malfunctioning or incorrect equipment calibration, for example, can then be examined and corrected without having only partially etched the wafer or wafers 34 in the reaction chamber 12 and ruined the wafer or wafers 34 as well as subsequent batches of wafers 34. Alternatively, the various control elements of the system 10 may be adjusted to bring the plasma intensity closer in line with the calibration curve 40.

FIG. 4 shows an illustrative partial plasma intensity curve 52 obtained during the progress of another etching process conducted after obtaining the calibration curve 40. During the etching process, the plasma intensity curve 52 is superimposed on a portion of the calibration curve 40 which corresponds to the main etching time segment “A”. As indicated by the plasma intensity curve 52, the plasma intensity of the etching process rose above the ideal or optimum plasma intensity which generated the calibration curve 40 obtained from the control of FIG. 2. When it is apparent that the plasma intensity has risen significantly (about 10% or more) above that of the calibration curve 40, the etching process is immediately terminated to prevent excessive etching of the wafer or wafers 34 in the reaction chamber 12. The plasma etching system 10 can then be examined for malfunctioning, for example, or other causes of the excessive plasma intensity, or the various control elements of the system 10 may be adjusted to bring the plasma intensity closer in line with the calibration curve 40 without having over-etched the wafer or wafers 34 in the reaction chamber 12 and ruined the wafer or wafers 34.

While the preferred embodiments of the invention have been described above, it will be recognized and understood that various modifications can be made in the invention and the appended claims are intended to cover all such modifications which may fall within the spirit and scope of the invention.

Having described my invention with the particularity set forth above, we claim:

1. A method of detecting abnormal conditions during a plasma etch process, said method comprising:
obtaining a calibration curve indicative of optimum plasma intensity for said plasma etch process;
conducting said plasma etch process;
obtaining a plasma intensity curve for said plasma etch process;
comparing said plasma intensity curve to said calibration curve; and
terminating said plasma etch process upon deviation of said plasma intensity curve from said calibration curve.

2. The method of claim 1 wherein said deviation of said plasma intensity curve from said calibration curve comprises a deviation of at least about 10%.

3. The method of claim 1 wherein said plasma etch process comprises a contact etch process.

4. The method of claim 3 wherein said deviation of said plasma intensity curve from said calibration curve comprises a deviation of at least about 10%.

5. A method of detecting abnormal conditions during a plasma etch process, said method comprising:
obtaining a calibration curve indicative of optimum plasma intensity for said plasma etch process;
conducting said plasma etch process;
obtaining a plasma intensity curve for said plasma etch process;
comparing said plasma intensity curve to said calibration curve; and
terminating said plasma etch process when said plasma intensity curve drops below said calibration curve.

6. The method of claim 5 wherein said terminating said plasma etch process when said plasma intensity curve drops below said calibration curve comprises terminating said plasma etch process when said plasma intensity curve drops at least about 10% below said calibration curve.

7. The method of claim 5 wherein said plasma etch process comprises a contact etch process.

8. The method of claim 7 wherein said terminating said plasma etch process when said plasma intensity curve drops below said calibration curve comprises terminating said plasma etch process when said plasma intensity curve drops at least about 10% below said calibration curve.

9. A method of detecting abnormal conditions during a plasma etch process, said method comprising:
obtaining a calibration curve indicative of optimum plasma intensity for said plasma etch process;
conducting said plasma etch process;
obtaining a plasma intensity curve for said plasma etch process;
comparing said plasma intensity curve to said calibration curve; and
terminating said plasma etch process when said plasma intensity curve rises above said calibration curve.

10. The method of claim 9 wherein said terminating said plasma etch process when said plasma intensity curve rises above said calibration curve comprises terminating said plasma etch process when said plasma intensity curve rises at least about 10% above said calibration curve.

11. The method of claim 9 wherein said plasma etch process comprises a contact etch process.

12. The method of claim 11 wherein said terminating said plasma etch process when said plasma intensity curve rises above said calibration curve comprises terminating said plasma etch process when said plasma intensity curve rises at least about 10% above said calibration curve.
